(19) United States
(12) Patent Application Publication
(10) Pub. No.: US 2001/0054775 A1
(43) Pub. Date: Dec. 27, 2001

(54) Method for the manufacture of molded polymeric devices using variable frequency microwaves

(75) Inventors: Mahendra P. Nandu, Rochester, NY (US); Richard J. Wrue, Rochester, NY (US)

Correspondence Address: Bausch & Lomb Incorporated, Law Department, One Bausch & Lomb Place, Rochester, NY, 14604-2701, US

(73) Assignee: Bausch & Lomb Incorporated

(21) Appl. No.: 09/804,633

(22) Filed: Mar. 9, 2001

Related U.S. Application Data
(63) Continuation of application No. 09/574,979, filed on May 19, 2000, now abandoned.

(51) Int. Cl. B29D 11/00; B29C 35/08

(52) U.S. Cl. 264/1.36; 264/40.1; 264/489

(57) ABSTRACT

The present invention relates to an improved method of manufacture of molded polymeric devices using variable frequency microwaves. Molded polymeric devices include, for example, contact lenses, corneal rings, intraocular lenses and drug delivery devices such as anterior or posterior chamber inserts. Contact lenses include soft and rigid gas permeable contact lenses as well as, lens blanks lathed into finished contact lenses. Molded polymeric devices further include medical devices such as prosthetics including hip joints. According to the present invention, a mold having a cavity the shape of the desired molded polymeric device, the cavity containing a composition comprising one or several monomers having double polymerizable bonds, is placed in a microwave chamber. The mold can be plastic, glass, ceramic or metal. Plastic is preferred. The mold is then swept with at least one range of microwave frequencies to polymerize the composition, thus forming the molded polymeric device. A range of frequencies includes a central frequency selected to rapidly heat the composition. A range is selected to generate a plurality of modes within the chamber. Sweeping is performed at a rate selected to avoid damage to the polymer formed and the mold.

### FIELD OF THE INVENTION

The present invention relates generally to an improved method of manufacture of molded polymeric devices using variable frequency microwaves. Preferably, these molded polymeric devices can be used on or in living subjects.

### BACKGROUND OF THE INVENTION

Traditional methods for forming molded polymeric devices such as contact lenses, intra-occular devices, etc. involve inducing a polymerization reaction in a mold of the device containing a monomer mix. Preferably, thermal or photopolymerization are used to cure the monomer mix. However, the process can take substantial periods of time. In addition, there are problems with respect to byproducts from the process. This can be a significant problem with products that may, for example, be inserted into the eyes. There are also limitations with the materials that may be employed and the materials that the molds are made of.

U.S. Pat. No. 4,390,482 to Feurer proposed using fixed frequency microwaves to form contact lenses. However, use of fixed-frequency microwaves present a number of problems. For example, it is known that fixed-frequency microwave such as microwave ovens typically have cold spots and hot spots. Such phenomena are attributed to the ratio of the wavelength to the size of the microwave chamber. With a relatively low-frequency microwave introduced into a small chamber, standing waves occur and thus the microwave power does not uniformly fill all of the space within the chamber, and the unaffected regions are not heated. In the extreme case, the oven chamber becomes practically a “single-mode” chamber.

Attempts have been made at mode stirring, or randomly deflecting the microwave “beam”, in order to break up the standing waves and thereby fill the chamber with the microwave radiation. One such attempt is the addition of rotating fan blades at the beam entrance of the chamber. This approach is limited by two factors, namely, the size of the mechanical perturbation and the speed at which the fan blades can be rotated. It will be appreciated that non-uniformities in the microwave power within the oven chamber will inevitably produce non-uniform curing.

Another method used to overcome the adverse effects of standing waves is to intentionally create a standing wave within a single-mode chamber such that the workpiece may be placed at the location determined to have the highest power (the hot spot). Thus, only the portion of the chamber in which the standing wave is most concentrated will be used. This poses a serious limitation insofar as only a small volume of material can be processed at one time.

U.S. Pat. No. 5,721,286 to Lauf et al., relates to a method of curing polymers using a variable frequency microwave system. U.S. Pat. Nos. 5,738,915 and 5,879,756 show the application of this technology to cure various polymers. However, the various polymers actually exemplified are all on or in a substrate, e.g., a semiconductor wafer. By contrast, the molded polymeric devices of the present invention are descrete molded units. It would be desirable to have an improved method for rapid and efficient curing of polymers. It would also be desirable to have a method to reduce the number of byproducts produced during curing.

### SUMMARY OF THE INVENTION

The present invention relates to an improved method of manufacture of molded polymeric devices using variable frequency microwaves. Molded polymeric devices include, for example, contact lenses, corneal rings, intraocular lenses and drug delivery devices such as anterior or posterior chamber inserts. Contact lenses include soft and rigid gas permeable contact lenses as well as lens blanks lathed into finished contact lenses. Molded polymeric devices further include medical devices such as prosthetics including hip joints.

According to the present invention, a mold having a cavity the shape of the desired molded polymeric device, the cavity containing a composition comprising one or several monomers having double polymerizable bonds, is placed in a microwave chamber. The mold can be plastic, glass, ceramic or metal. Plastic is preferred. The mold is then swept with at least one range of microwave frequencies to polymerize the composition, thus forming the molded polymeric device. A range of frequencies includes a central frequency selected to rapidly heat the composition. A range is selected to generate a plurality of modes within the chamber. Sweeping is performed at a rate selected to avoid damage to the polymer formed and the mold. The microwave power may be electronically tuned during frequency sweeping to control the required temperature curing profile of the polymer.

In addition, effluent, such as gas, vapor, and the like, may be removed during frequency sweeping. Effluent removal may occur by creating either a slight positive pressure within the chamber or by creating a slight vacuum within the chamber. For example, the microwave chamber may be purged with an inert gas, such as nitrogen, argon, neon, helium, krypton, xenon, and the like. The extent of cure of the polymer may be determined by detecting power reflection for each microwave frequency within a range to provide power reflection data, and then comparing the power reflection data with a predetermined set of power reflection data. The present invention is advantageous because sweeping a mold with a range of microwave frequencies facilitates curing with uniformity in three dimensions.

The rate of cure is controlled, by controlling microwave power, microwave frequency, and sweep rate. Sweeping a mold is a much better method of controlling the rate of cure than is tuning of the chamber because sweeping sustains uniform energy distribution without causing hot spots within the microwave chamber.

### BRIEF DESCRIPTION OF THE DRAWINGS

FIG. 1 illustrates microwave chamber containing a mold for forming a molded polymeric device in a variable frequency microwave chamber.

FIG. 2 illustrates the power profile for Example 1.

FIG. 3 illustrates the power profile for Example 2.

### DETAILED DESCRIPTION OF THE INVENTION

The present invention relates to an improved method of manufacture of molded polymeric devices using variable frequency microwaves. Molded polymeric devices include, for example, contact lenses, corneal rings, intraocular lenses and drug delivery devices such as anterior or posterior chamber inserts. Contact lenses include soft and rigid gas permeable contact lenses as well as, lens blanks lathed into finished contact lenses. Molded polymeric devices further include medical devices such as prosthetics including hip joints.

The present invention can be used with all contact lenses such as conventional soft and rigid gas permeable lenses and the composition of the monomer mix and the specific monomers used to form the lenses are not critical. The present invention is preferably employed with soft contact lenses such as those commonly referred to as hydrogel lenses prepared from monomers including but not limited to hydroxyethyl methacrylate, vinyl-pyrrolidone, glycerol methacrylate, methacrylic acid and acid esters. However, any combination of lens forming monomers capable of forming a polymer useful in making contact lenses may be used. Hydrophobic lens forming monomers may also be included such as those containing silicone moieties.

According to the present invention, a plastic mold having a cavity the shape of the desired molded polymeric device, the cavity containing a composition comprising one or several monomers having double polymerizable bonds, is placed in a microwave chamber. The mold is then swept with at least one range of microwave frequencies to polymerize the composition, thus forming the molded polymeric device.

The composition comprising a monomer used in forming the molded polymeric devices typically also includes crosslinking agents, strengthening agents, free radical initiators and/or catalysts and the like as is well known in the art. Further, suitable solvents or diluents can be employed in the composition, provided such solvents or diluents do not adversely affect or interfere with the polymerization process.

Cast molding techniques used in the methods of the present invention are well known. Generally, for contact lenses, conventional cast molding techniques employ thermoplastic male and female mold halves of predetermined configuration which imparts the desired shape and surface configurations to the lenses formed therebetween. Examples of cast molding processes are taught in U.S. Pat. Nos. 4,113,224; 4,121,896; 4,208,364; 4,208,365 and 5,681,510 which are fully incorporated herein by reference. Of course, many other cast molding teachings are available which can be used with the present invention providing the molds are made from thermoplastic materials substantially transparent with respect to microwave radiation. Such material include, for example, those polymers and copolymers which contain predominantly polyolefins such as polyethylene, polypropylene, and polystyrene. Polypropylene is the most preferred plastic mold material.

In the method of the present invention a plastic mold having a cavity the shape of the desired molded polymeric device, the cavity containing a composition comprising one or several monomers having double polymerizable bonds, is placed in a microwave chamber. The mold is swept with a range of microwave frequencies, and, if necessary the microwave power is adjusted to control the temperature of the polymer formed therein. The range of frequencies preferably has a central frequency selected to rapidly heat the polymer. The range of frequencies is also selected to generate a plurality of modes within the chamber. Sweeping is performed at a rate selected to prevent damage to the polymer.

The step of adjusting microwave power may be performed simultaneously with the step of sweeping the mold with a range of microwave frequencies. The purpose of the step of adjusting microwave power is to control the temperature of the mold and polymer. By controlling the temperature, the desired thermal profile of the polymer during curing can be maintained.

In addition, a step of determining the extent of cure of the polymer by detecting power reflection for the polymer for each microwave frequency within a range to provide power reflection data can be provided. This power reflection data can then be compared with a predetermined set of power reflection data. Preferably, the step of determining the extent of cure occurs simultaneously with the steps of frequency sweeping and adjusting microwave power.

A step of removing effluent from the microwave chamber during the steps of sweeping and adjusting microwave power can also be included. Typically volatile effluent, including gases, vapors, and the like, are produced during the curing of polymers and it is desirable to remove these because they can condense on the surface of the polymer and cause various irregularities therein which can affect the physical properties of the polymer. The step of removing effluent from a microwave chamber may include purging the chamber with an inert gas to create a slight positive pressure therein. Exemplary gases used in the semiconductor industry and which can be used for purging include nitrogen, argon, neon, helium, krypton, xenon, and the like. A preferable inert gas for purging is nitrogen. However, other gases may be utilized, as would be known to those having skill in the art. The step of removing effluent from the microwave chamber may also include establishing a slight vacuum within the chamber during the steps of sweeping and adjusting microwave power.

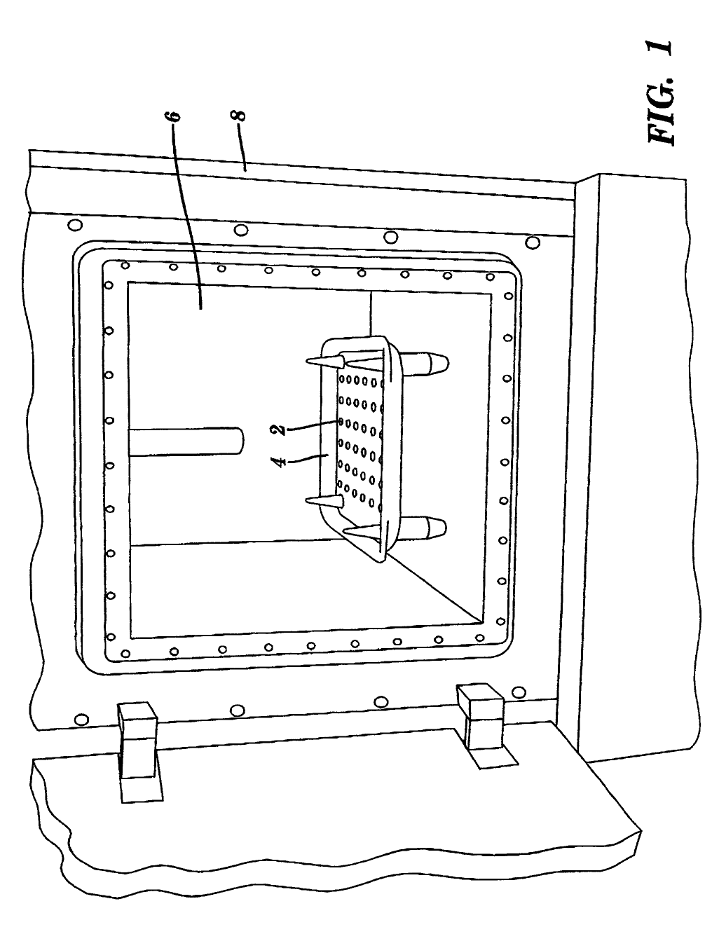

Typically, a mold 2 containing one or more monomers in the formulation is placed on a holder 4, and the holder and mold are placed within a chamber 6 of a microwave chamber 8 as illustrated in FIG. 1. The primary purpose of the holder 4 is to hold the mold during processing. However, the holder 4 may be configured to enclose the mold and to facilitate maintaining a uniform temperature throughout the mold and the polymer during microwave processing.

The present method can substantially reduce the time required to cure polymers over conventional curing techniques. For example, using the method of the present invention, polymer curing time can be reduced from hours to minutes with the same efficiency of curing seen with conventional methods or better.

Other ways of maintaining uniform temperature of a mold during microwave processing include controlling the temperature within the microwave chamber. As would be understood by those having skill in the art, this can be accomplished in a variety of ways. For example, an inert gas used to create a positive pressure within the chamber during the step of effluent removal, can be heated and regulated to maintain the appropriate temperature within the chamber.

Exemplary microwave chambers for carrying out the present invention are described in U.S. Pat. Nos. 5,321,222 and 5,961,871 to Bible et al., the disclosures of which are incorporated herein by reference in their entirety. The step of sweeping a mold with a range of microwave frequencies and the step of adjusting microwave power is preferably performed within a multi-mode microwave chamber of the type described in the Bible et al. Patents and available commercially from Lambda Technologies, Inc. (Raleigh, N.C.). In general, a microwave chamber for carrying out the present invention typically includes a microwave signal generator or microwave voltage-controlled oscillator for generating a low-power microwave signal for input to the microwave chamber. A first amplifier may be provided to amplify the magnitude of the signal output from the microwave signal generator or the microwave voltage-controlled oscillator. A second amplifier is provided for processing the signal output by the first amplifier. A power supply is provided for operation of the second amplifier. A directional coupler is provided for detecting the direction of a signal and further directing the signal depending on the detected direction. Preferably a high-power broadband amplifier, such as, but not limited to, a traveling wave tube (TWT), tunable magnetron, tunable klystron, tunable twystron, and a tunable gyrotron, is used to sweep a range of frequencies of up to an octave in bandwidth and spanning the 300 MHz to 300 GHz frequency range. A range of microwave frequencies for curing a polymer in accordance with the present invention may include virtually any number of frequencies, and is not limited in size.

Use of variable frequency processing, as disclosed herein, enhances uniform processing from one molded device to the next because placement of each mold within the chamber is not critical. By contrast, with single frequency microwave processing, each mold must be oriented in precisely the same way within the chamber to achieve identical and repeatable processing time and quality.

The practical range of frequencies within the electromagnetic spectrum from which microwave frequencies may be chosen is about 0.90 GHz to 40 GHz. Every polymer exposed to microwave energy typically has at least one range or window of microwave frequencies that is optimum for curing of the polymer. Above or below a particular optimum window of frequencies, curing may not occur optimally. A window may vary depending on, for example, mold configuration and material composition. A window may also vary depending on the nature of the polymer. The selection of a window for a particular polymer is typically obtained either empirically through trial and error, or theoretically using power reflection curves and the like.

Within a window of frequencies selected for a particular polymer, it is generally desirable to select the frequencies that result in the shortest time to effectively cure the polymer. Preferably, a mold is processed with a subset of frequencies from the upper end of each window. More modes can be excited with higher frequencies than with lower frequencies, thereby resulting in shorter cure times. Additionally, better uniformity in curing is typically achieved by using the upper-end frequencies within a window. However, any subset of frequencies within a window of frequencies may be used.

The term “window”, as defined above, refers to a range of microwave frequencies bounded on one end by a specific frequency and bounded on the opposite end by a different specific frequency.

Each window preferably has a central frequency that is selected to optimally heat a particular polymer. This means that the selected frequency is the frequency at which the monomer composition with in the mold cavity is at or near maximum absorption of microwave energy. Microwave energy heats by coupling at the molecular level with the material to which it is applied producing volumetric heating within the material. When microwave energy is optimally tuned for heating the material at a central frequency within a window of frequencies, the heating is very efficient as compared with conventional convection heat ovens.

The rate at which the different frequencies are launched is referred to as the sweep rate. This rate may be any value, including, but not limited to, milliseconds, and minutes. Preferably, the sweep rate is as rapid as practical for the particular polymer. In addition, the sweep rate is selected so that an optimum number of modes are generated within the chamber. Sweep rate may also be selected based on the thickness of the molded device to be cured.

The uniformity in processing afforded by frequency sweeping provides flexibility in how a mold is oriented within the microwave chamber, and permits a plurality of molds to be stacked during processing. Maintaining each mold in precisely the same orientation is not required to achieve uniform processing.

Preferably, the variable frequency microwave oven is under computer control. Under computer control, the microwave chamber is tuned to a particular frequency, preferably the optimum incident frequency for a particular size and type of mold and composition contained therein, and then is programmed to sweep around this central frequency to generate a plurality of modes and rapidly move them around the chamber to provide a uniform energy distribution. In addition, the optimum degree of coupling frequency may change during the processing of a polymeric material within the mold. This is because the dielectric properties of polymers can change during heating. Accordingly, it is preferred that the central frequency be adjustable, preferably under computer control, to compensate automatically for such changes.

The step of determining the extent of cure of a polymer can be determined in situ by measuring the shift in dielectric properties of the polymer layer, as described in U.S. Pat. No. 5,648,038, the disclosure of which is incorporated herein by reference in its entirety. When a mold is irradiated with microwave energy within a microwave chamber, the interaction between the microwave energy and the mold is influenced by the applied microwave frequency, chamber/cavity dimensions, mold configuration, and the location of the mold within the chamber. This interaction can be monitored using the percentage of the power reflected back to the microwave launcher. This percentage is calculated by dividing the reflected power (Pr) by the input power (Pi). When a mold is irradiated with a range or window of frequencies from a variable frequency microwave source, for example 1 to 20 GHz, a power reflection curve as a function of incident frequencies can be obtained. The shape of this curve comprises intrinsic peaks that are related to the dielectric properties, shape, and configuration of the mold and polymer.

For every mold, in a given position within a microwave chamber, there is a unique curve, or “signature curve”, over the launched microwave frequency range. Any variation in this signature curve, as indicated by frequency shift and/or magnitude change of the intrinsic peaks, is solely a function of changing material properties or conditions. For example, if the dimensions of a microwave chamber are held constant, and two molds, each comprised of the same material and having substantially identical shapes and sizes, are positioned within the chamber in substantially the same way, the signature curves generated for each mold, upon being irradiated with the substantially same range of microwave frequencies, will be substantially identical. Any variation or shifts between the two signature curves is an indication that the molds do not comprise material in the same condition or state. The magnitude of the shift depends on the shape, dielectric properties, and location of the mold within the chamber.

Consequently, the stage of cure of a polymer is determinable from signature curve shifts. As would be understood by those having skill in the art, it is not necessary to produce signature curves in printed form or on a computer screen. Intrinsic peak shifts can be calculated and product characteristics determined independent of a tangible signature curve. The power reflection data necessary to produce a signature curve may simply be analyzed within a processor, such as a computer.

### EXAMPLE 1

### Manufacture of Hydrophilic Contact Lenses

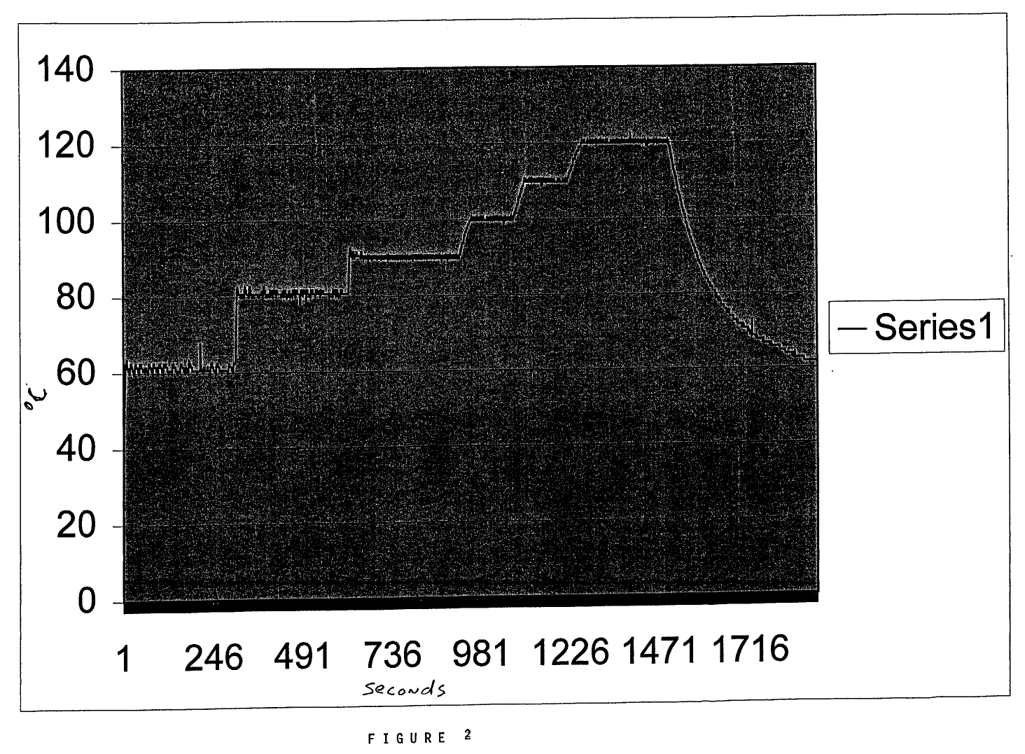

The monomer formulation contains 2-hydroxyethyl methacrylate, N-vinyl pyrrolidone, a crosslinker and thermal initiator. After injecting the monomer mix into polypropylene mold cavities, they were subject to the power profile shown in FIG. 2. The profile represents a 24 minute curing cycle as compared with a required conventional convection oven cycle of 2.5 hours. Results were as follows:

Unreacted Monomer in the Pre-extracted Lens (Method of the Present Invention)

| NVP | HEMA |
|---|---|
| μg/mg of lens mat'l | μg/mg of lens mat'l |
| 39.1 | ND |

ND = Not Detectable

It is to be noted that the microwave cure profile in this example was not optimized as values of 17.6 and 19.8 μg/mg of lens mat'l residuals have been achieved. Conventional thermal curing process historically gave 60-80 μg/mg of unreacted NVP monomers in the cured dry lens prior to extraction.

Unreacted Monomers in Pre-extracted Lens (Convection Thermal Cure)

| NVP | HEMA |
|---|---|
| μg/mg of lens mat'l | μg/mg of lens mat'l |
| 67.5 | ND |

ND = Not Detectable

Refractive Index & Water Content

| Microwave Cured | | | Convection Thermal Cure | | |
|---|---|---|---|---|---|
| | RI | % WC | | RI | % WC |
| AVERAGE | 1.3814 | 71.52 | AVERAGE | 1.3837 | 70.17 |
| Std. Dev. | 0.0002 | 0.14 | Std. Dev. | 0.0007 | 0.42 |

Average lens clarity = Clear

### EXAMPLE 2

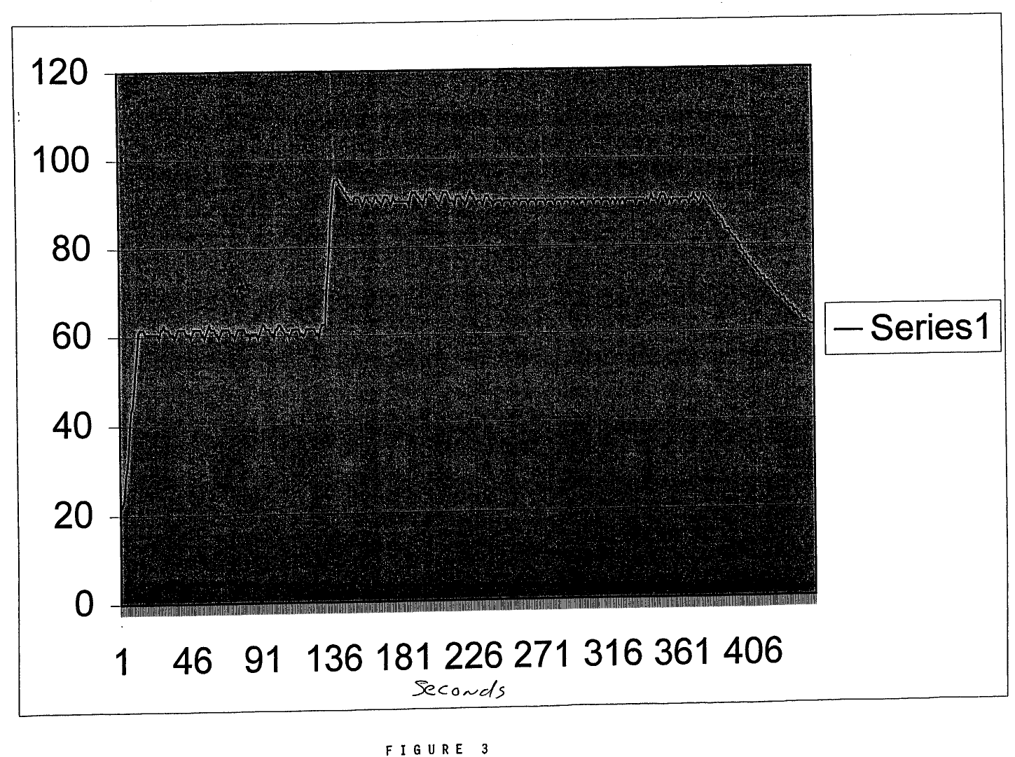

This example represents variable frequency microwave curing of a urethane pre-polymer, TRIS and dimethylacrylamide as monomers, and a thermal initiator. Lenses were cast in polypropylene mold cavities. The power profile is shown in FIG. 3, and represents a 7-minute curing cycle. The results achieved were as follows:

Average Percent Water was measured to be 26.23% on fully processed lenses which is in the required range.

Modulus (g/mm²)=49(3)

Tensile Strength (g/mm²)=31(8)

Elongation (%)=167(44)

Tear strength=10(0.6)

( )=standard deviation

Gas Chromatography Results of Lenses:

| | DMA | Thermal | Tris Meth. |
|---|---|---|---|
| | (μg/mg of | Initiator | (μg/mg of |
| Sample | mat'l) | (μg/mg of mat'l) | mat'l) |
| Dry released lens lot | 1.71 | ND | 0.73 |
| Prior to extraction | | | |

ND = Not Detectable

The chromatography obtained in this analysis meet all system suitability requirements.

In the drawings and specification, there have been disclosed typical preferred embodiments of the invention and, although specific terms are employed, they are used in a generic and descriptive sense only and not for purposes of limitation, the scope of the invention being set forth in the following claims.

What is claimed is:

1. A method of curing a molded polymeric device, said method comprising the steps of:
(a) placing at least one mold having a cavity the shape of the desired molded polymeric device, the cavity containing a composition comprising one or several monomers having double polymerizable bonds, in a microwave chamber;
(b) sweeping said at least one mold with at least one range of microwave frequencies, said at least one range having a central frequency selected to rapidly heat said composition, said at least one range selected to generate a plurality of modes within said chamber, said sweeping performed at a rate selected to avoid damage to said mold and cured composition contained therein.

2. The method of claim 1, further comprising the steps of:
(c) adjusting microwave power during said step (b) to control the temperature of said mold and cured composition contained therein;
(d) continuously determining, during said step (a), an extent of cure of said composition by detecting power reflection for said composition for each microwave frequency within said at least one range to provide power reflection data, and comparing said power reflection data to a predetermined set of power reflection data; and
(e) removing effluent produced during said steps (a) and (b) from said microwave chamber.

3. The method of claim 1, wherein the molded polymeric device is selected from the group consisting of a contact lens, corneal rings, intraocular lenses, anterior chamber inserts and posterior chamber inserts.

4. The method of claim 1, wherein the molded polymeric device is a contact lens.

5. The method of claim 1, wherein the molded polymeric device is an intraocular lens.
